(19) United States
(12) Patent Application Publication
(10) Pub. No.: US 2007/0156873 A1
(43) Pub. Date: Jul. 5, 2007

(54) Methods, systems, and products for provisioning communications services

(76) Inventor: Douglas O'Neil, Marietta, GA (US)

Correspondence Address: SCOTT P. ZIMMERMAN, PLLC, PO BOX 3822, CARY, NC, 27519, US

(21) Appl. No.: 11/323,657

(22) Filed: Dec. 30, 2005

(51) Int. Cl. G06F 15/173

(52) U.S. Cl. 709/223

(57) ABSTRACT

Methods, systems, and products are disclosed for provisioning communications services. Provisioning information for a third party service provider is stored in a provisioning database. A query from a network provider is received, and the provisioning information is retrieved. A response is sent to the network provider, and the response includes the provisioning information.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to communications and to computers and, more particularly, to provisioning electronic communications, to telephony communications, to wireless communications, and to client-server processing.

Provisioning a customer's communications services is challenging. In today's communications market, a customer may select from many communications services. Some of these communications services are offered by network operators, while other services are offered by third party service providers. Whenever a third party provides a communications service, a network operator must correctly establish the information required to provide that third party service. Most times the network operator must individually negotiate the provisioning details with each third party provider. These negotiations are tedious and waste scarce resources.

Provisioning of voicemail service provides an example. BELLSOUTH® and CINGULAR® offer customers a common wireless/wireline voicemail account. That is, a single voicemail account retains messages from the customer's CINGULAR® cell phone service and from the customer's BELLSOUTH® residential phone service. The residential landline network operator provisions the customer's residential telephone number so that unanswered calls are forwarded to this single, common voicemail account. The customer's cellular network operator must likewise provision to the same voicemail account. The landline network operator and the cellular network operator must then negotiate acceptable commands to permit access to each other's provisioning systems. If BELLSOUTH® wanted to establish a similar common voicemail box service for Verizon's wireless customers or for Sprint's wireless customers, BELLSOUTH® would have to negotiate the same provisioning access. What is needed, then, are methods, systems, and products that simplify the provisioning of third party communications services.

### SUMMARY

The aforementioned problems, and other problems, are reduced, according to the exemplary embodiments, using methods, systems, and products that provision communications services. When a third party offers a communications service, the exemplary embodiments store the provisioning information in a database. The third party service provider makes this database accessible to network operators. Whenever a network operator needs provisioning information for the third party communications service, the network operator simply queries the database. Because each third party service provider maintains their own provisioning database, the network operator is not forced to negotiate with each and every third party service provider. The exemplary embodiments also describe a common repository for all third party provisioning information. The exemplary embodiments, then, provide an elegant and simple solution to the challenges of provisioning communications services.

The exemplary embodiments describe a method for provisioning communications services. Provisioning information for a third party service provider is stored in a provisioning database. A query from a network provider is received, and the provisioning information is retrieved. A response is sent to the network provider, and the response includes the provisioning information.

In another of the embodiments, a system is disclosed for provisioning communications services. A provisioning database is stored in memory, and a processor communicates with the memory. The processor stores provisioning information for a third party service provider in the provisioning database. The processor receives a query from a network provider and retrieves the provisioning information. The processor sends a response to the network provider, and the response comprises the provisioning information.

In yet another embodiment, a computer program product is also disclosed for provisioning communications services. The computer program product comprises a computer-readable medium storing computer-readable instructions. These instructions store provisioning information for a third party service provider in a provisioning database. When a query from a network provider is received, the provisioning information is retrieved. A response is sent to the network provider, and the response includes the provisioning information.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a schematic illustrating a system for provisioning communications services, according to exemplary embodiments;

FIG. 2 is a schematic illustrating a system for provisioning third-party email service, according to more exemplary embodiments;

FIG. 3 is a schematic illustrating a system for provisioning third-party voicemail service, according to more exemplary embodiments;

FIG. 4 is a schematic further illustrating a system for provisioning third-party communications service, according to yet more exemplary embodiments;

FIG. 5 is a schematic illustrating the use of common interfaces, according to still more exemplary embodiments;

FIG. 6 is a schematic illustrating a common repository for provisioning information, according to exemplary embodiments;

FIGS. 7-9 are schematics illustrating a customer's provisioning profile, according to more exemplary embodiments;

FIG. 10 is another schematic illustrating the customer's provisioning profile, according to yet more exemplary embodiments;

FIG. 11 is another schematic illustrating the customer's provisioning profile, according to yet more exemplary embodiments;

FIG. 12 depicts a possible operating environment for exemplary embodiments;

FIG. 13 is a schematic illustrating alternative operating environments;

FIG. 14 is a schematic further illustrating various communications devices for provisioning communications services, according to the exemplary embodiments; and

FIG. 15 is a block diagram further illustrating the communications device, according to yet more of the exemplary embodiments

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

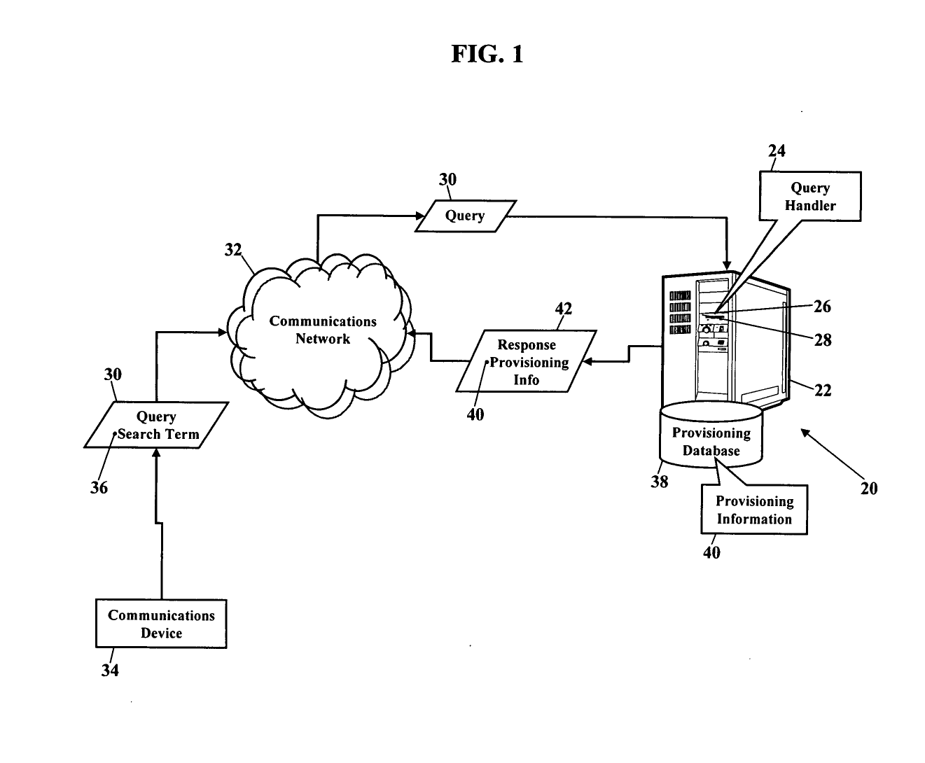

FIG. 1 is a schematic illustrating a system for provisioning communications services, according to exemplary embodiments. The system 20 is illustrated as a computer 22, yet the system 20 may be any processor-controlled device. A query handler 24 is stored in the memory 26 of the computer 22, and a processor 28 communications with the memory 26. The query handler 24 may be a software application that receives and processes database search requests. The query handler 24, for example, receives a query 30 via a communications network 32. The query 30 has a packetized structure according to a packet protocol and originates from a communications device 34. The query 30 comprises a query term 36.

The query handler 24 then queries a provisioning database 38. The provisioning database 38 is stored in the memory 26 of the computer 22. The provisioning database 38 stores provisioning information 40 for communications services. The provisioning information 40 is any information needed to provide access to data, to hardware, and/or to services, such as authorization to systems, applications and databases based on a customer's/subscriber's identity. The provisioning information 40 would provide access to servers and other hardware resources, access to networks, and access to software services or applications. The query handler 24 includes processor-executable instructions for receiving the query 30, for processing the query 30, and for determining whether the provisioning database 38 contains the query term 36. If some table or map in the provisioning database 38 contains the query term 36, the query handler 24 instructs the processor 28 to retrieve the provisioning information 40 associated with the query term 36. If the provisioning information 40 is retrieved, the query handler 24 instructs the processor 28 to construct a response 42, and the response 42 includes the provisioning information 40. If the provisioning information 40 is not retrievable, or if the query term 36 is not found, the response 42 includes an error message. The response 42 communicates via the communications network 32 to a communications address associated with the originating communications device 34.

The provisioning information 40 describes any communications service. The provisioning information 40, for example, is any data or information needed to provide access to, or service for, landline communications service. The provisioning information 40, additionally, may be any data or information needed to provide cellular service, Internet access service, any wireless service, pager service, email service, voicemail service, or any other messaging or communications feature or service.

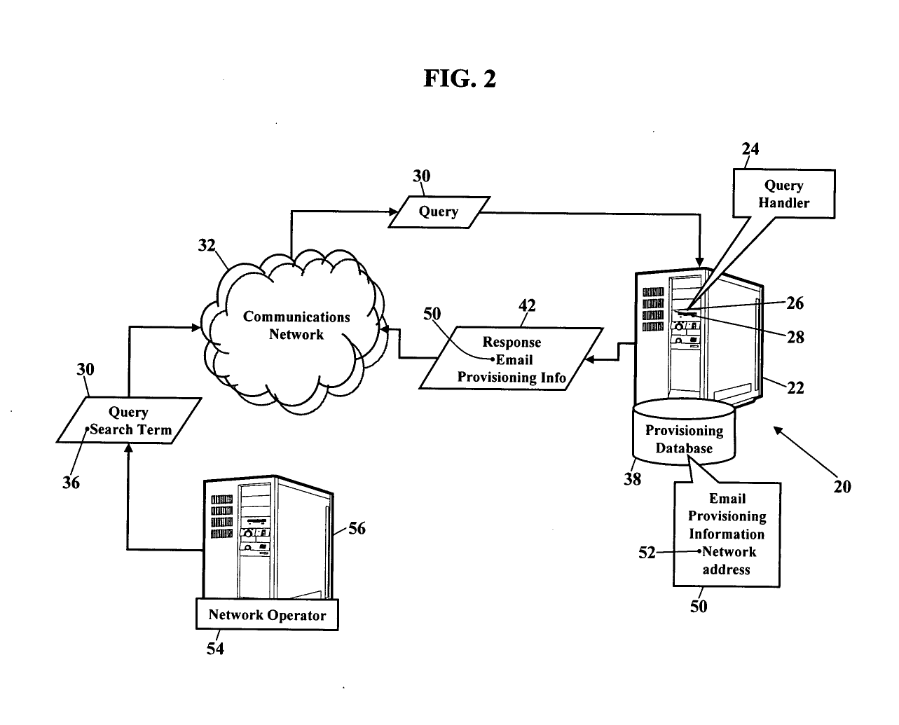

FIG. 2 is a schematic illustrating a system for provisioning third-party email service, according to more exemplary embodiments. Here the provisioning database 38 stores provisioning information for a third party email service provider. This third party email service provider provides email or other electronic messaging service(s). The third party email service provider, however, may or may not provide network access, as does a network operator or carrier. The first party is the customer, the second party is the network operator, and the third party service provider is any outside, non-network operator entity that provides a service or feature on behalf of the network operator.

FIG. 2, then, illustrates email provisioning information 50. Here the provisioning database 38 stores the email provisioning information 50 for a third party email service provider. This third party email service provider provides email service(s). The third party email service provider, however, may or may not provide network access, as does a network operator or carrier. The email provisioning information 50, for example, may include email network addresses 52 for an incoming mail server and/or for an outgoing mail server. The email provisioning information 50 may also include access or security information, such as a username and password.

When a network operator 54 needs the email provisioning information 50, the network operator 54 sends the query 30. As FIG. 2 illustrates, a network operator's server 56 sends the query 30 via the communications network 32. The query handler 24 instructs the processor 28 to query the provisioning database 38 and to retrieve the email provisioning information 50 associated with the query term 36. The query handler 24 then instructs the processor 28 to send the response 42, and the response 42 includes the email provisioning information 50. The response 42 communicates via the communications network 32 to the communications address associated with the network operator's server 56.

The provisioning database 38, then, may be accessed by any network operator. Any network operator that needs a customer's email provisioning information may access the provisioning database 38. That is, the third party email service provider makes their provisioning information available to any network operator. Any wireline or landline network operator, cellular network operator, or wireless network operator may access the provisioning database 38 and retrieve the email provisioning information 50. Remember, there are currently many third party email service providers. AOL®, YAHOO®, MICROSOFT® and many other third parties provide email service. Because the provisioning database 38 is accessible to any and all network operators, each network operator need not individually negotiate with each third party email service provider to provision email service. The exemplary embodiments permit the network operator 54 to more simply query the provisioning database 38.

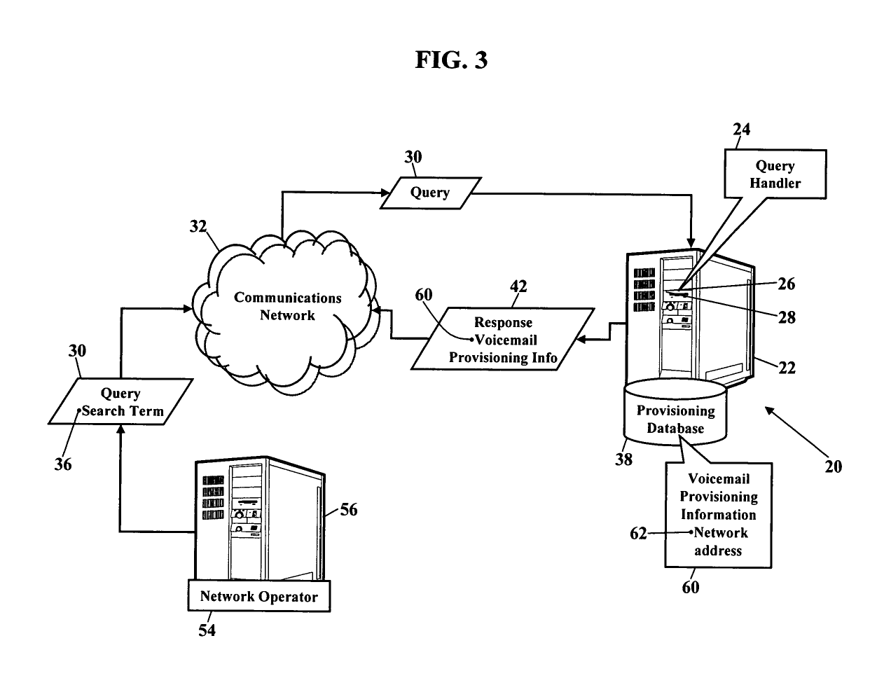

FIG. 3 is a schematic illustrating a system for provisioning third-party voicemail service, according to more exemplary embodiments. Here the provisioning database 38 stores voicemail provisioning information 60 for a third party voicemail service provider. This third party voicemail service provider provides voicemail service(s). The voicemail provisioning information 60 may include voicemail network addresses 62 for a voicemail server. When the network operator 54 needs the voicemail provisioning information 60, the network operator 54 sends the query 30. The processor 28 retrieves the voicemail provisioning information 60 associated with the query term 36. The processor 28 then sends the response 42, including the requested voicemail provisioning information 60. The response 42 communicates via the communications network 32 to the communications address associated with the network operator's server 56.

The third party's voicemail service may be accessed by different network operators. Some customers may have a common or shared voicemail box that is accessed by a cellular network operator, a landline or wireline network operator, and/or a wireless network operator. Suppose, for example, a customer has a single voicemail account that stores voicemail messages from the customer's cellular phone and from the customer's residential home phone. When the third party voicemail service provider configures their voicemail service for this customer, the voicemail service provider stores the customer's voicemail provisioning information 60 in the provisioning database 38. The third party voicemail service provider, for example, would configure the provisioning database 38 to accept voicemails from the customer's residential landline network operator and the customer's cellular network operator. The residential landline network operator, for example, would provision the customer's residential telephone number such that unanswered calls are forwarded to this single, common voicemail account. The customer's residential telephone number may provisioned with a call_forward_busy and/or a call_forward_no_answer to a network address associated with that single, common voicemail account. The customer's cellular network operator, likewise, provisions the customer's cellular service to call forward on busy and/or to call forward no answer to that network address associated with the single, common voicemail account. Whenever any network operator needs the customer's voicemail provisioning information 60, the network operator need only query the provisioning database 38. The network operator need not individually negotiate with the third party voicemail service provider to establish voicemail service. That is, each network operator need not negotiate commands and formats to establish and access the customer's voicemail service.

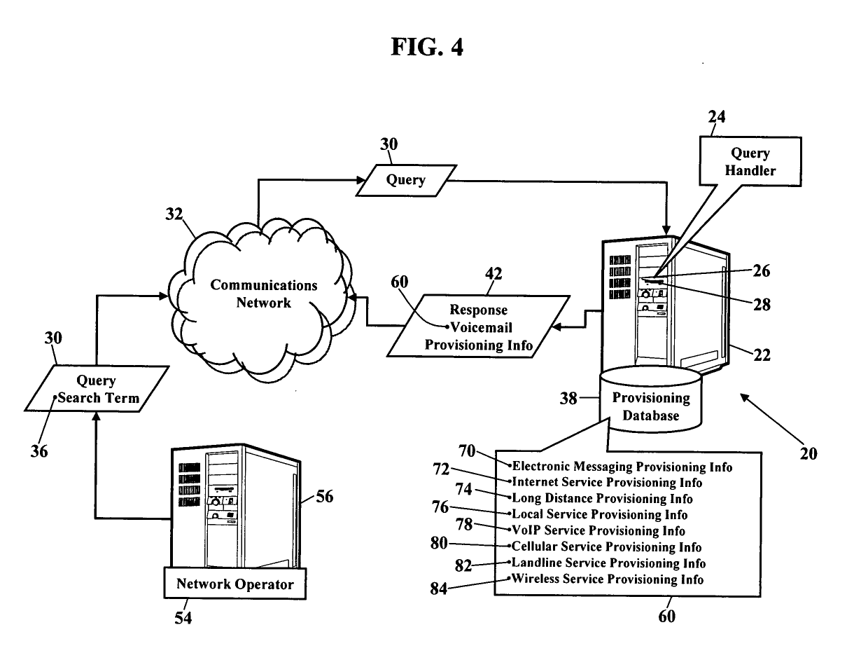

FIG. 4 is a schematic further illustrating a system for provisioning third-party communications service, according to yet more exemplary embodiments. Here the provisioning database 38 is illustrated as storing provisioning information for other third party communications services. The provisioning database 38, for example, may store electronic messaging provisioning information 70, Internet service provisioning information 72, and long distance provisioning information 74. The provisioning database 38 may also store local service provisioning information 76, Voice over Internet Protocol (VoIP) service provisioning information 78, and cellular service provisioning information 80. The provisioning database 38 may also store landline service provisioning information 82 and wireless service provisioning information 84. The provisioning database 38 may also store provisioning information for a reseller of any communications service, a reseller of network access, and/or any other provider of third-party communications service. Whenever any network operator needs any provisioning information related to any of these third party communications services, the network operator need only query the provisioning database 38. The network operator need not individually negotiate with the each party communications service provider.

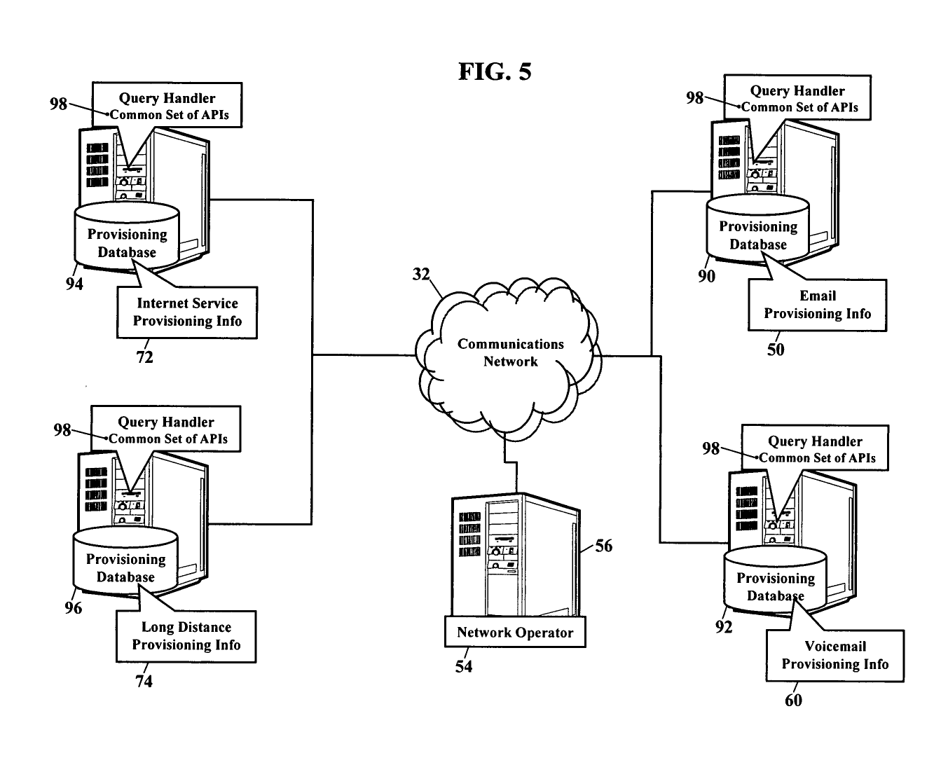

FIG. 5 is a schematic illustrating the use of common interfaces, according to still more exemplary embodiments. Because a communications customer may subscribe to a variety of communications services, the network operator 54 may need to interface with different third party providers and/or vendors of services. Each of these third party providers may utilize different hardware and software configurations. Ordinarily such a diverse environment presents compatibility problems for the network operator 54.

FIG. 5 illustrates this diverse environment. The network operator's server 56, for example, may access the email provisioning information 50 stored in a third party email service provider's database 90. The network operator's server 56 may also need to access the voicemail provisioning information 60 stored in a third party voicemail service provider's database 92. The network operator's server 56 may also need to access the Internet service provisioning information 72, and the long distance provisioning information 74, respectively stored in each third party provider's database 94 and 96. (Although not shown for simplicity, the network operator's server 56 may also access other third party service provider's database.) Each of these third party providers may utilize different hardware and software configurations. Ordinarily such a diverse environment presents compatibility problems for the network operator 54.

FIG. 5, however, also illustrates a common set 98 of application programming interfaces (APIs). Because each third party service provider may utilize different hardware, software, and manufacturer configurations, the common set 98 of application programming interfaces provides commonly understood commands, functions, and/or calls. The common set 98 of application programming interfaces defines how each third party provider's provisioning database is accessed via their respective query handlers. Each third party provider's query handler understands and utilizes the common set 98 of application programming interfaces. Each third party service provider may utilize application programming interfaces that are uniquely specified by the network operator 54. All third party service providers, however, could adopt an industry wide, universal set of definitions. All network operators and all third party service providers utilize the common set 98 of application programming interfaces. The common set 98 of application programming interfaces helps alleviate compatibility problems in a diverse hardware and software environment. The common set 136 of application programming interfaces, for example, provide common functions, commands, and/or requests to a Voice over Internet Protocol application, SIP applications and/or protocols, or 3G wireless networks (such as WCDMA and OFDMA). The common set 136 of application programming interfaces may also interact with network-independent APIs, such as those proposed by The Parlay Group and available from www.parlay.org and incorporated herein by reference. Access to the common set 136 of application programming interfaces may be controlled by a multilevel access control system and/or a multilevel pricing scheme. Access to the common set 136 of application programming interfaces may additionally or alternatively be controlled by an interaction logic control to help mitigate potential conflicts between APIs of different systems (such as between an email server and voice server, for example). Access to the common set 136 of application programming interfaces may additionally or alternatively be controlled by subscriber specific controls. Service combinations may include any and all of the following APIs/features in multiple networks, subscriber devices, or separate application servers provided by third parties. Because application programming interfaces are known, this patent will not further describe such interfaces. If the reader desires a more detailed explanation, the reader is invited to consult the following sources, with each source incorporated herein by reference: U.S. Pat. No. 5,652,866 to Aldred et al. (Jul. 29, 1997); U.S. Pat. No. 5,668,988 to Mason et al. (Sep. 16, 1997); U.S. Pat. No. 6,826,758 to Chew et al. (Nov. 30, 2004); U.S. Pat. No. 6,961,944 to Chew et al. (Nov. 1, 2005); Published U.S. Patent Application 2003/0105887 to Cox et al. (Jun. 5, 2003); Published U.S. Patent Application 2003/0126584 to Creamer et al. (Jul. 3, 2003); Published U.S. Patent Application 2004/0007121 to Graves et al. (Jan. 15, 2004); Published U.S. Patent Application 2004/0045015 to Haji-Aghajani et al. (Mar. 4, 2004); and Published U.S. Patent Application 2005/0223392 to Cox et al. (Oct. 6, 2005).

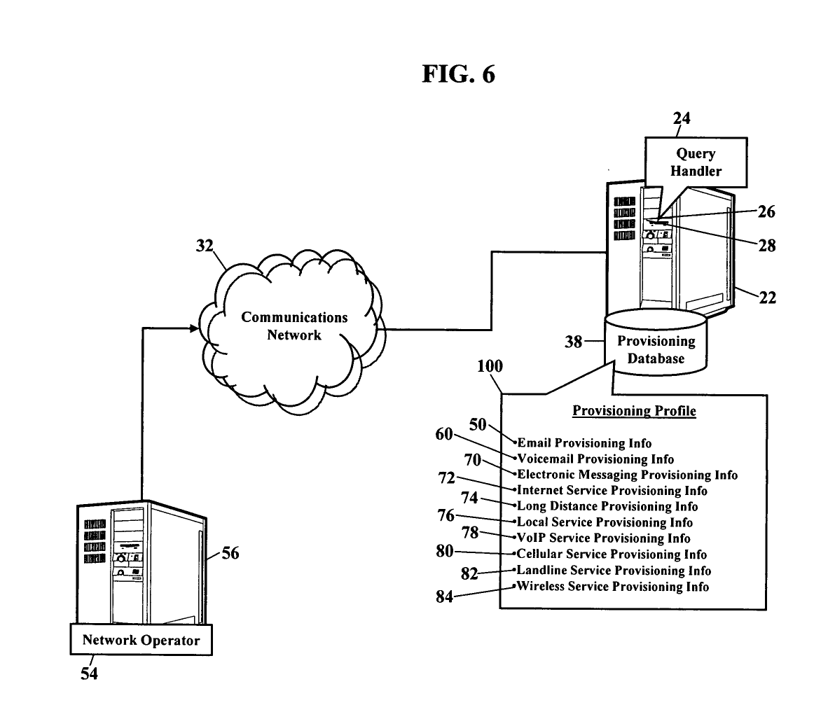

FIG. 6 is a schematic illustrating a common repository for provisioning information, according to exemplary embodiments. Here, the provisioning database 38 stores all a customer's provisioning information. That is, each communications customer has a provisioning profile 100. All provisioning information, for all of the customer's third party communications services, is maintained in the customer's provisioning profile 100. FIG. 6, as an example, illustrates the customer's provisioning profile 100 storing the customer's email provisioning information 50, the customer's voicemail provisioning information 60, the customer's electronic messaging provisioning information 70, the customer's Internet service provisioning information 72, and the customer's long distance provisioning information 74. All of the customer's provisioning information, associated with any and/or multiple third party communications providers, is stored within the customer's provisioning profile 100. If the customer subscribes to a third party communications service, the provisioning information for that third party communications service is accessible via the customer's provisioning profile 100. Whenever the network operator's server 56 needs to query for the customer's provisioning information, the network operator's server 56 may query the customer's provisioning profile 100. When the customer chooses to keep the records of their third party communication services in the provisioning database 38, and the database is operated by an entity other than a network provider, the customer has the flexibility of changing network operators, and, therefore, is able to seek the best deal from a network operator. Exemplary embodiments permit the customer to continue using the communication services of their favorite service providers (such as voice mail, long distance, email, instant messaging, and others). The customer's provisioning profile 100 thus represents a common repository (e.g., a single Internet Protocol address and a single file name) for all of the customer's provisioning information.

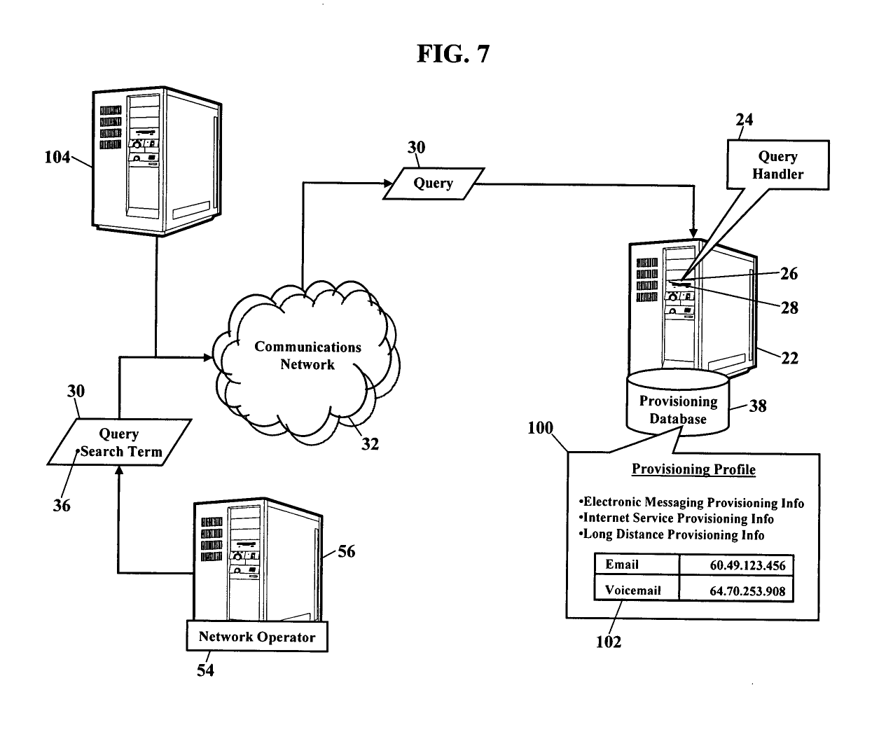

FIGS. 7-9 are schematics further illustrating the customer's provisioning profile 100, according to more exemplary embodiments. Here the customer's provisioning profile 100 comprises a table or map 102 of provisioning information. The table or map 102 of provisioning information associates provisioning information to a network address. If the customer's provisioning profile 100 does not contain a particular provisioning information, then the table or map 102 identifies from where that particular provisioning information may be obtained. Suppose, for example, the customer's provisioning profile 100 does not store the customer's email provisioning information. For whatever reason, that email provisioning information is remotely maintained at another server 104 having another network address. When the query handler 24 receives the query 30 from the network operator's server 56, the query 30 requests the customer's email provisioning information. Because the customer's provisioning profile 100 does not contain the email provisioning information, the query handler 24 instructs the processor 26 to query the table or map 102. The table or map 102 indicates that the customer's email provisioning information is stored at the network address (illustrated as “60.49.123.456”) of the another server 104. The network address may also include a filename, such as “http://60.49.123.456/directory/filename.ext.”

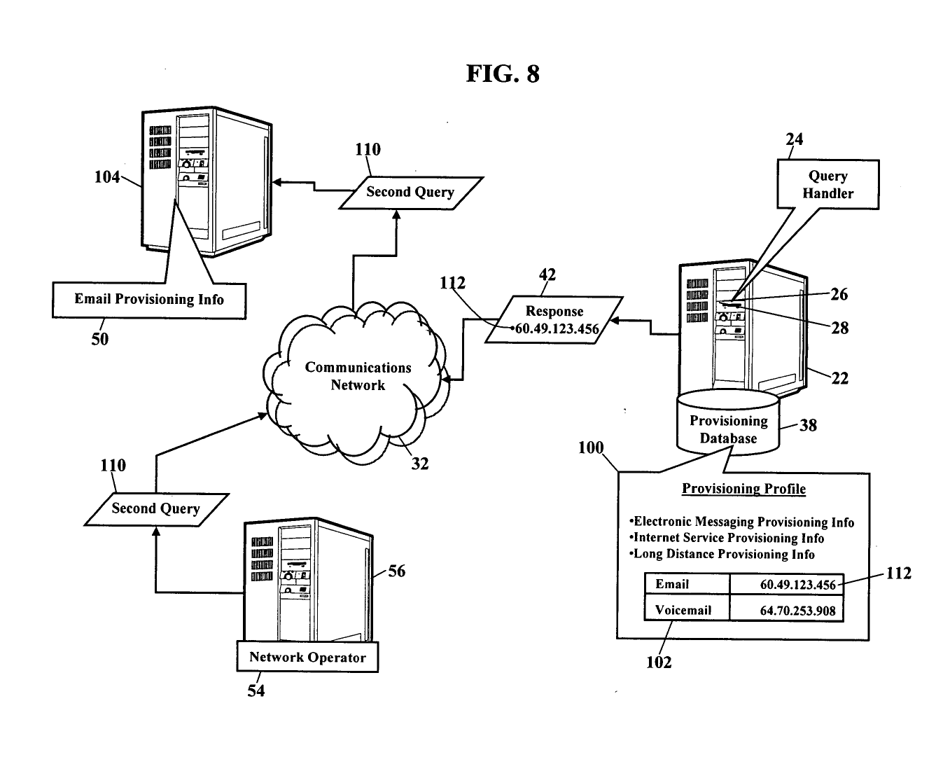

FIG. 8 illustrates a second query 110. Because the customer's email provisioning information is stored at the another server 104, here the query handler 24 instructs the processor 28 to retrieve the network address 112 for the customer's email provisioning information. The query handler 24 then instructs the processor 28 to send the response 42, and the response 42 includes the network address 112 for the customer's email provisioning information. The network operator's server 56 would then have to send the second query 110 to the another server 104 to retrieve the customer's email provisioning information 50.

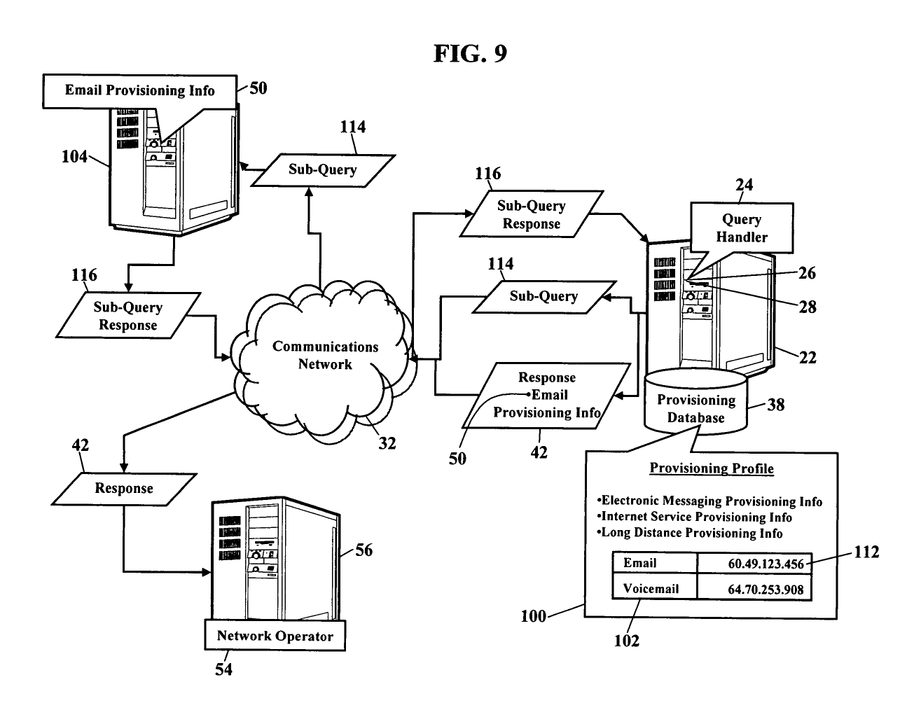

FIG. 9, however, illustrates a sub-query 114. Here, when the customer's email provisioning information 50 is located at the another server 104, the query handler 24 itself obtains that information. When the table or map 102 indicates the customer's email provisioning information 50 is stored at the another server 104, the processor 28 sends the sub-query 114 to the another server 104. The another server 104 returns a sub-query response 116, and the sub-query response 116 contains the customer's email provisioning information 50. Now that the query handler 24 has retrieved the customer's email provisioning information 50, the processor 28 is instructed to pass that information to the network operator's server 56. The processor 28 sends the response 42, and the response 42 includes the customer's email provisioning information 50.

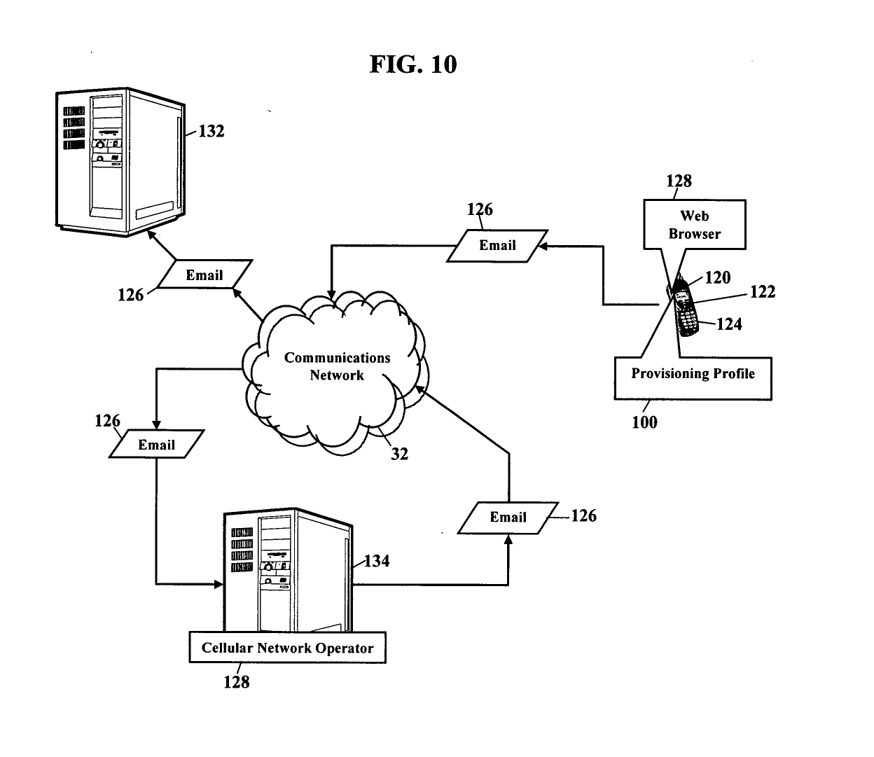

FIG. 10 is another schematic illustrating the customer's provisioning profile 100, according to yet more exemplary embodiments. Here, however, the customer's provisioning profile 100 is locally maintained by the customer. FIG. 10 illustrates the customer's provisioning profile 100 stored within memory 120 of the customer's communications device 122. Although the communications device 122 is shown as a wireless phone 124, later paragraphs will describe other configurations. Here, then, the customer maintains their own provisioning profile 100. Whatever relationships the customer maintains with third party service providers, those relationships are provisioned in the customer's provisioning profile 100. The customer defines the provisioning profile 100 to specify what third parties provide what communications services. Suppose, for example, the customer selects AOL® as their email service provider. When the customer clicks or otherwise selects to send an email 126, here the cellular network operator 128 need not be directly involved in provisioning that email. When the customer sends the email 126, the customer's web browser 130, instead, queries the customer's provisioning profile 100. The web browser 130 queries the customer's provisioning profile 100 for a network address of an outgoing email server 132. If the customer has multiple email service providers (as do some customers), the customer may toggle or otherwise switch between email service providers. The cellular network provider 128, however, is not involved in provisioning that email. The cellular network provider's server 134 may merely forward the email 126 to its destination (e.g., the outgoing email server 132). The cellular network provider 128, then, becomes a carrier of content and is not bogged down in the provisioning details. The cellular network provider 128 no longer wastes resources in negotiating amongst the various email service providers.

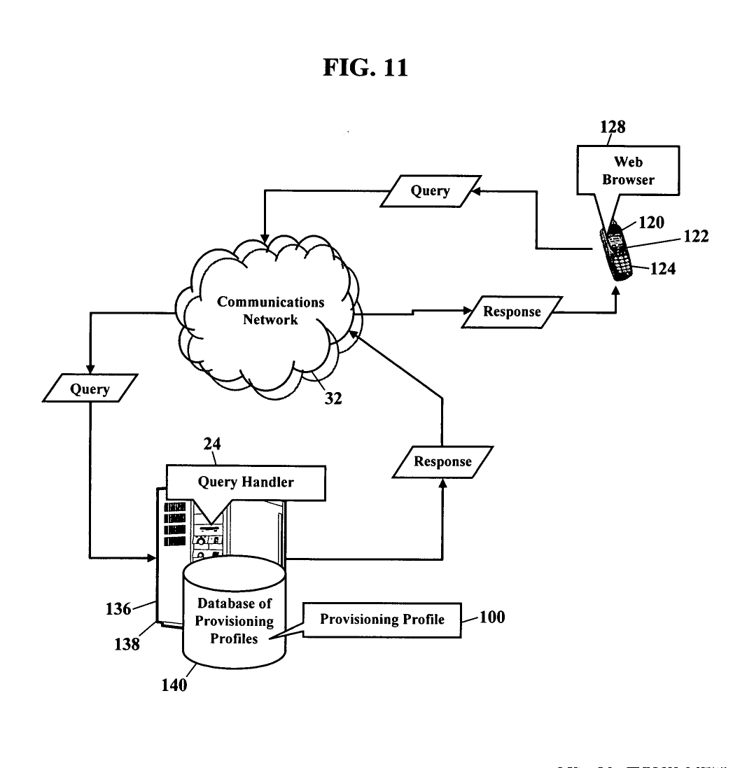

FIG. 11 is another schematic illustrating the customer's provisioning profile 100, according to yet more exemplary embodiments. Here the customer's provisioning profile 100 is remotely maintained by the customer. The customer still maintains their own provisioning profile 100, but that provisioning profile 100 is stored in a networked computer 136. The customer still specifies what third parties provide what communications services, but those relationships are remotely stored in the networked computer 136. Now, the networked computer 136 may be a personal computer in the customer's residence. More likely, however, the networked computer 136 is a server 138. The server 138 may be partially or entirely dedicated to maintaining a database 140 of customer provisioning profiles. Whenever the web browser 128 needs provisioning information, the web browser 128 queries the database 140 of customer provisioning profiles. The query handler 24 retrieves the provisioning information from the customer's provisioning profile and sends a response, as earlier explained.

The exemplary embodiments may be applied regardless of networking environment. The communications network 32 may be a cable network operating in the radio-frequency domain and/or the Internet Protocol (IP) domain. The communications network 32, however, may also include a distributed computing network, such as the Internet (sometimes alternatively known as the “World Wide Web”), an intranet, a local-area network (LAN), and/or a wide-area network (WAN). The communications network 32 may include coaxial cables, copper wires, fiber optic lines, and/or hybrid-coaxial lines. The communications network 32 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

The exemplary embodiments may also be applied regardless of web browser design or vendor. Many different browsers are available. Microsoft's INTERNET EXPLORER® is perhaps the most common browser in the current market (INTERNET EXPLORERS is a registered trademark of Microsoft Corporation, One Microsoft Way, Redmond Wash. 98052-6399, 425.882.8080, www.Microsoft.com). Other web browser designs, available from other vendors, may also be modified, retrofitted, or designed to include the exemplary embodiments. NETSCAPE®, for example, is another vendor of web browsers that may incorporate the exemplary embodiments (NETSCAPE® is a registered trademark of Netscape Communications Corporation). Other web browsers include Mozilla's Firefox, Opera, and Apple's Safari.

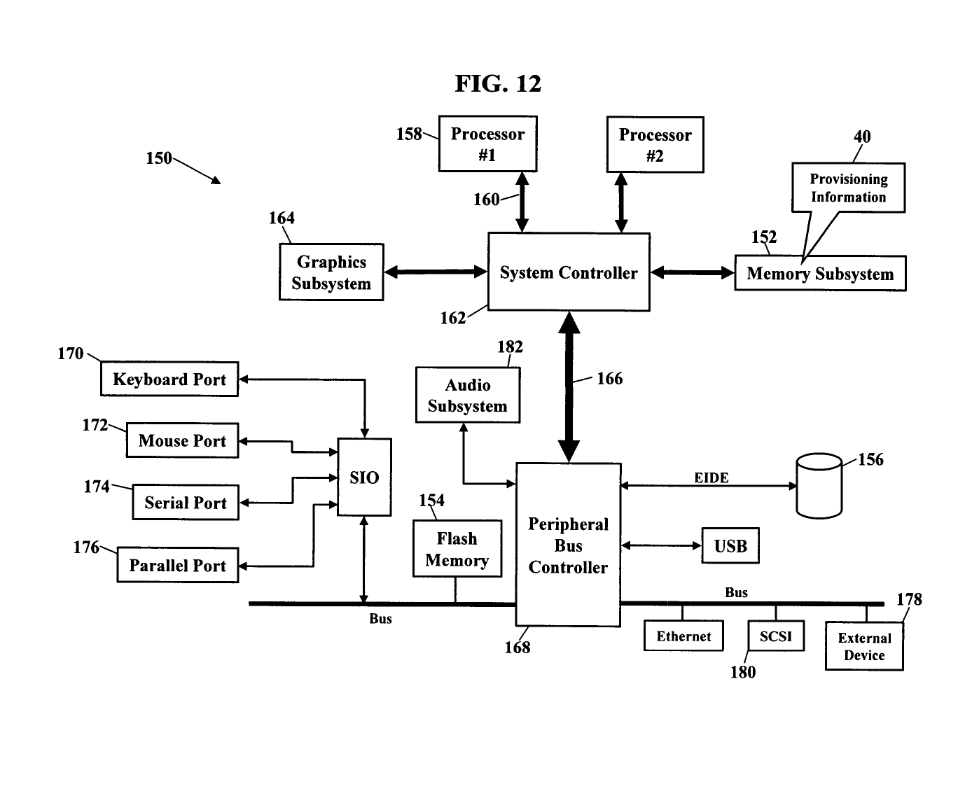

FIG. 12 depicts another possible operating environment for exemplary embodiments. FIG. 12 is a block diagram showing the provisioning information 40 residing in a processor-controlled system 150 (such as the computer 22, the another server 104, and the customer's communications device 124 variously shown in FIGS. 1-11). FIG. 12, however, may also represent a block diagram of any computer or communications device in which the provisioning information 40 may store. The provisioning information 40 stores within a system memory device. The provisioning information 40, for example, is shown residing in a memory subsystem 152. The provisioning information 40, however, could also reside in flash memory 154 or peripheral storage device 156. The computer system 150 also has one or more central processors 158 executing an operating system. The operating system, as is well known, has a set of instructions that control the internal functions of the computer system 150. A system bus 160 communicates signals, such as data signals, control signals, and address signals, between the central processor 158 and a system controller 162. The system controller 162 provides a bridging function between the one or more central processors 158, a graphics subsystem 164, the memory subsystem 152, and a PCI (Peripheral Controller Interface) bus 166. The PCI bus 166 is controlled by a Peripheral Bus Controller 168. The Peripheral Bus Controller 168 is an integrated circuit that serves as an input/output hub for various peripheral ports. These peripheral ports could include, for example, a keyboard port 170, a mouse port 172, a serial port 174, and/or a parallel port 176 for a video display unit, one or more external device ports 178, and external hard drive ports 180 (such as IDE, ATA, SATA, or SCSI). The Peripheral Bus Controller 168 could also include an audio subsystem 182. Those of ordinary skill in the art understand that the program, processes, methods, and systems described herein are not limited to any particular computer system or computer hardware.

One example of the central processor 158 is a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described herein are not limited to any particular manufacturer's central processor.

According to an exemplary embodiment, any of the WINDOWS® (WINDOWS® is a registered trademark of Microsoft Corporation, One Microsoft Way, Redmond Wash. 98052-6399, 425.882.8080, www.Microsoft.com) operating systems may be used. Other operating systems, however, are also suitable. Such other operating systems would include the UNIX® operating system (UNIX® is a registered trademark of the Open Source Group, www.opensource.org), the UNIX-based Linux operating system, WINDOWS NT®, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described herein are not limited to any particular operating system.

The system memory device (shown as memory subsystem 152, flash memory 154, or peripheral storage device 156) may also contain an application program. The application program cooperates with the operating system and with a video display unit (via the serial port 174 and/or the parallel port 176) to provide a Graphical User Interface (GUI). The Graphical User Interface typically includes a combination of signals communicated along the keyboard port 170 and the mouse port 172. The Graphical User Interface provides a convenient visual and/or audible interface with a user of the computer system 150.

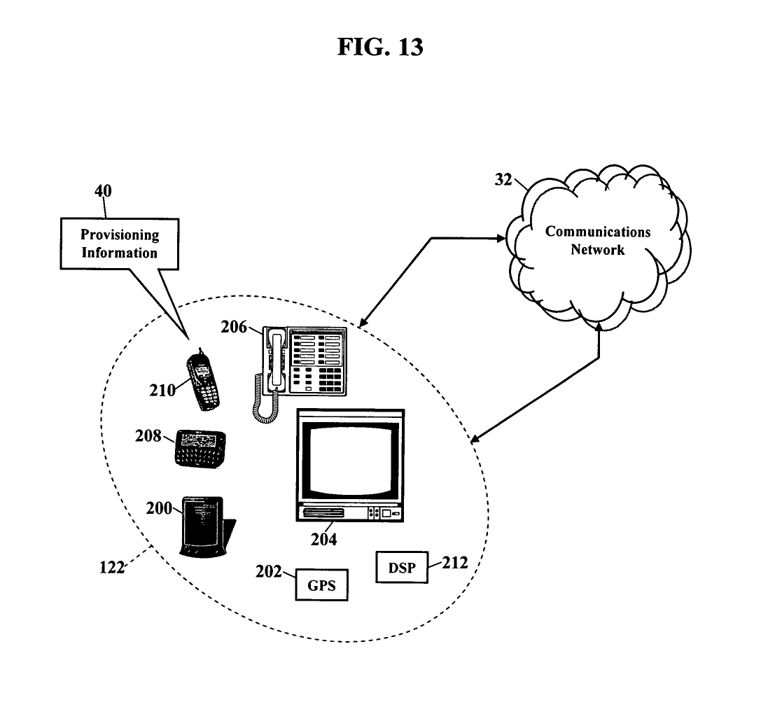

FIG. 13 is a schematic illustrating still more exemplary embodiments. FIG. 13 illustrates that the provisioning information 40 may alternatively or additionally store within various other communications devices 122. FIG. 13, for example, illustrates that the provisioning information 40 may entirely or partially store within a personal digital assistant (PDA) 200, a Global Positioning System (GPS) device 202, an interactive television 204, an Internet Protocol (IP) phone 206, a pager 208, a cellular/satellite phone 210, or any computer system and/or communications device utilizing a digital signal processor (DSP) 212. The communications device 122 may also include watches, radios, vehicle electronics, clocks, printers, gateways, and other apparatuses and systems.

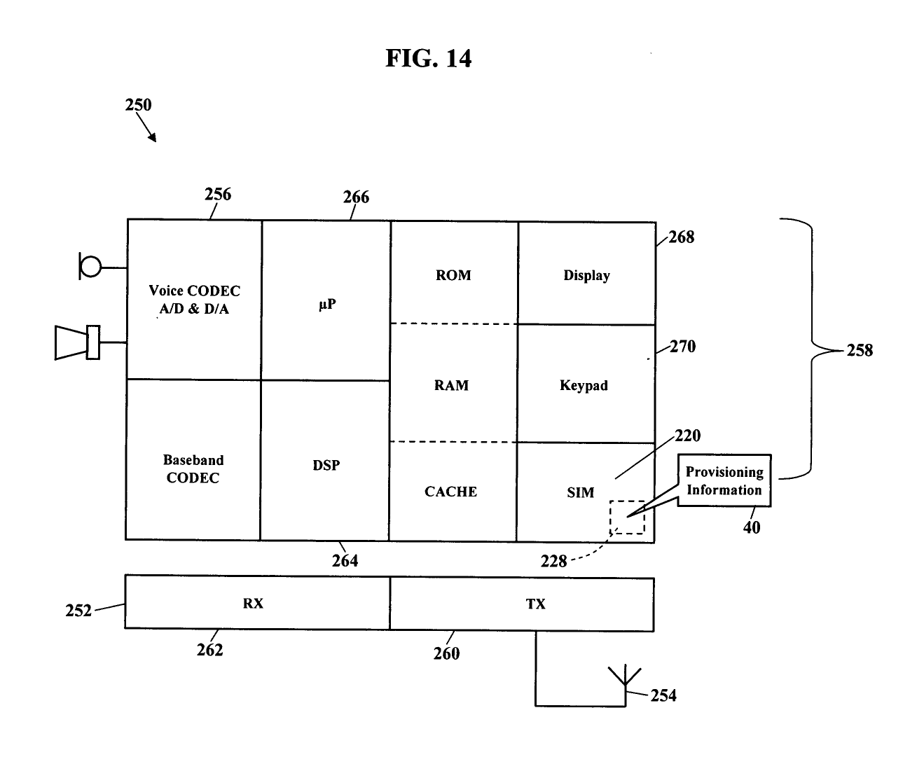

FIG. 14 is a schematic further illustrating various communications devices for provisioning communications services, according to the exemplary embodiments. FIG. 14 is a block diagram of another communications device 250 storing or utilizing any portion of the provisioning information 40. In one embodiment, the communications device 250 comprises a radio transceiver unit 252, an antenna 254, a digital baseband chipset 256, and a man/machine interface (MMI) 258. The transceiver unit 252 includes transmitter circuitry 260 and receiver circuitry 262 for receiving and transmitting radio-frequency (RF) signals. The transceiver unit 252 couples to the antenna 254 for converting electrical current to and from electromagnetic waves. The digital baseband chipset 256 contains a digital signal processor (DSP) 264 and performs signal processing functions for audio (voice) signals and RF signals. As FIG. 14 shows, the digital baseband chipset 256 may also include an on-board microprocessor 266 that interacts with the man/machine interface (MMI) 258. The man/machine interface (MMI) 258 may comprise a display device 268, a keypad 270, and a Subscriber Identity Module 220. The on-board microprocessor 266 performs GSM protocol functions and control functions for the radio circuitry 260 and 262, for the display device 268, and for the keypad 270. The on-board microprocessor 266 may also interface with the Subscriber Identity Module 220 and with the provisioning information 40 residing in the memory module 228 of the Subscriber Identity Module 220. Those skilled in the art will appreciate that there may be many suitable architectural configurations for the elements of the communications device 250. If the reader desires a more detailed explanation, the reader is invited to consult the following sources: LAWRENCE HARTE et al., GSM SUPERPHONES 105-120 (1999); SIEGMUND REDL et al., GSM AND PERSONAL COMMUNICATIONS HANDBOOK 389-474 (1998); and JOACHIM TISAL, GSM CELLULAR RADIO TELEPHONY 99-130 (1997), with each incorporated herein by reference.

The exemplary embodiments may be utilized regardless of signaling standard. As those of ordinary skill in the art recognize, FIG. 14 illustrates a Global System for Mobile (GSM) communications device. That is, the communications device utilizes the Global System for Mobile (GSM) communications signaling standard. Those of ordinary skill in the art, however, also recognize the exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard.

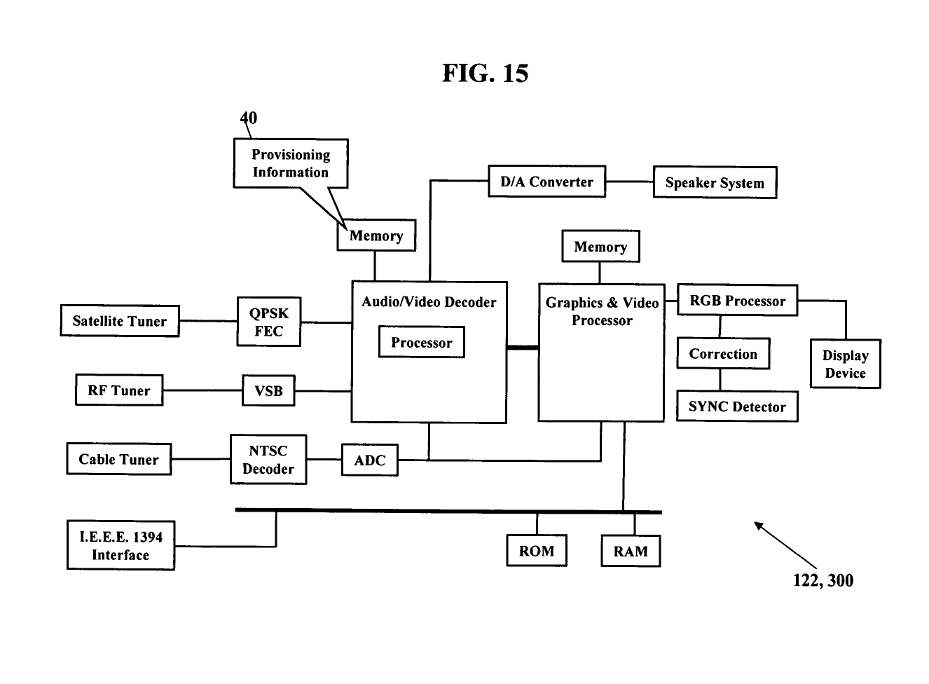

FIG. 15 is a block diagram further illustrating the communications device 122, according to yet more of the exemplary embodiments. Here the communications device 122 is shown as a digital high definition television (HDTV) system 300. Although an HDTV system is shown, the exemplary embodiments are applicable to any television design. The concepts, for example, are applicable to analog circuitry, digital circuitry, analog signals, and/or or digital signals. The television may include an encoder/decoder, such as an embedded set-top box. The term “television,” however, may encompass a stand-alone set-top box that is a separate component from the television. The television may also utilize any display device technology, such as a cathode-ray, a liquid crystal, a diode, digital micromirror, light processor, or plasma. The provisioning information 40 may be stored in any memory location or device in the television 300. FIG. 15, though, is only a simplified block diagram. The operating and engineering principles are already known in the art and will not be repeated here. If, however, the reader desires more information on the television, the reader is directed to the following sources: MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004), with each incorporated herein by reference.

The query handler 24, the provisioning information 40, and/or the customer's provisioning profile 100 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow easy dissemination. A computer program product comprises the computer-readable medium storing processor-executable or computer-readable instructions, as the exemplary embodiments describe.

The exemplary embodiments may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for provisioning communications services, comprising:
storing provisioning information for a third party service provider in a provisioning database;
receiving a query from a network provider;
retrieving the provisioning information; and
sending a response to the network provider, the response comprising the provisioning information.

2. A method according to claim 1, wherein the step of storing the provisioning information comprises storing email provisioning information for an email service provider.

3. A method according to claim 2, wherein the step of retrieving the provisioning information comprises retrieving a network address for the email service provider.

4. A method according to claim 1, wherein the step of storing the provisioning information comprises storing voicemail provisioning information for a voicemail service provider.

5. A method according to claim 4, wherein the step of retrieving the provisioning information comprises retrieving a network address for the voicemail service provider.

6. A method according to claim 1, wherein the step of receiving the query comprises receiving a common interface used by all network providers when querying for the provisioning information.

7. A method according to claim 1, further comprising storing provisioning information for all third party service providers in the provisioning database, such that the provisioning database is a common repository for all of a customer's provisioning information.

8. A system, comprising:
a provisioning database stored in memory; and
a processor communicating with the memory,
wherein the processor stores in the provisioning database provisioning information for a third party service provider,
the processor receives a query from a network provider,
the processor retrieves the provisioning information, and
the processor sends a response to the network provider, the response comprising the provisioning information.

9. A system according to claim 8, wherein the provisioning database stores email provisioning information for an email service provider.

10. A system according to claim 9, wherein the processor retrieves a network address for the email service provider.

11. A system according to claim 8, wherein the provisioning database stores voicemail provisioning information for a voicemail service provider.

12. A system according to claim 11, wherein the processor retrieves a network address for the voicemail service provider.

13. A system according to claim 8, wherein the processor receives a common interface used by all network providers when querying for the provisioning information.

14. A system according to claim 8, wherein the processor stores provisioning information for all third party service providers in the provisioning database, such that the provisioning database is a common repository for all of a customer's provisioning information.

15. A computer program product comprising a computer-readable medium storing computer-readable instructions for performing the steps:
storing provisioning information for a third party service provider in a provisioning database;
receiving a query from a network provider;
retrieving the provisioning information; and
sending a response to the network provider, the response comprising the provisioning information.

16. A computer program product according to claim 15, further comprising computer code for storing email provisioning information for an email service provider.

17. A computer program product according to claim 16, further comprising computer code for retrieving a network address for the email service provider.

18. A computer program product according to claim 15, further comprising computer code for storing voicemail provisioning information for a voicemail service provider.

19. A computer program product according to claim 18, further comprising computer code for retrieving a network address for the voicemail service provider.

20. A computer program product according to claim 15, further comprising computer code for receiving a common interface used by all network providers when querying for the provisioning information.
